(19) United States
(12) Patent Application Publication
(10) Pub. No.: US 2016/0078226 A1
(43) Pub. Date: Mar. 17, 2016

(54) DETECTION OF A SECURITY EVENT

(71) Applicant: Hewlett-Packard Development Company, L.P., Houston, TX (US)

(72) Inventors: Chris I. Dalton, Bristol (GB); Boris Balacheff, Lyon (FR); Perry V. Lea, Eagle, ID (US)

(73) Assignee: Hewlett-Packard Development Company, L.P., Houston, TX (US)

(21) Appl. No.: 14/888,845

(22) PCT Filed: May 14, 2013
(86) PCT No.: PCT/US13/40970

§ 371 Date: Nov. 3, 2015

(51) Int. Cl. G06F 21/55

(52) U.S. Cl. CPC G06F 21/554

(57) ABSTRACT

The present disclosure relates to an integrated circuit. The integrated circuit includes a memory controller. The integrated circuit includes a first memory coupled to the memory controller. The integrated circuit includes a processor core coupled to the memory controller. The integrated circuit includes a secure core that includes a second memory. The secure core is configured to inspect the first memory and detect a security event.

### CROSS-REFERENCE TO RELATED APPLICATION

This application is a United States National Stage Application of International Patent Application No. PCT/US2013/040970, filed on May 14, 2013, the contents of which are incorporated by reference as if set forth in their entirety herein.

### BACKGROUND

As computing devices become more prevalent in homes and businesses, security becomes more important. Security events such as viruses and other malicious software intrusions can be harmful to various types of computing devices. It may be necessary to have tools and techniques to detect and remedy these security events. Many computing devices use software-based security solutions. These software-based solutions run on a host processor of the computing device. For example, virus detection software can run on the host processor and regularly check the processor and operating system for recognized software intrusions.

### BRIEF DESCRIPTION OF THE DRAWINGS

Certain examples are described in the following detailed description and in reference to the drawings, in which:

FIG. 1 is a block diagram of a system for detecting a security event;

FIG. 2 is a block diagram of a system for detecting a security event in a multi-core computing device;

FIG. 3 is a block diagram of a mapping between physical memory and virtual memory; and

FIG. 4 is a process flow diagram of a method for detecting a security event.

### DETAILED DESCRIPTION

The present disclosure is generally related to detecting a security event in a computing device. Because software-based security solutions run on the host processor of a computing device, the software-based security solutions are vulnerable to the same security events that can harm the host processor. They can also slow down the performance of processes already running on the host processor. The present disclosure describes a system-on-chip (SOC) or an application-specific integrated circuit (ASIC) with one or more processing cores sharing a memory space. The SOC or ASIC will also include a discrete secure core with its own memory. The secure core can inspect the shared memory space to detect and remedy security events of the processing cores. With its own dedicated memory, the secure core can monitor activities of the processing cores without being vulnerable to attacks.

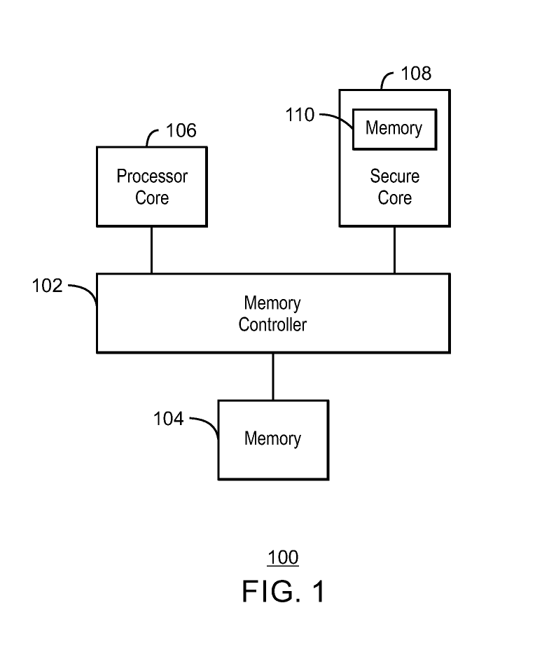

FIG. 1 is a block diagram of a system for detecting a security event. The system 100 may be a system-on-chip (SOC) or an application-specific integrated circuit (ASIC) of an electronic device. The system 100 may be part of a general purpose computing device, such as a desktop computer, a laptop computer, a tablet computer, or a smartphone. The system 100 may be part of an embedded system on an electronic device such as a printer, a scanner, a copy machine, a fax machine, or a video game console.

The system 100 can include a memory controller 102 coupled to a first memory 104. The memory controller 102 can be a shared ASIC memory space with a common bus. The memory controller 102 can be configured to manage the flow going to and from the first memory 104. A processor core 106 and a secure core 108 can also be coupled to the memory controller 102. The processor core 106 can function as the main core of the electronic device. The processor core 106 can operate using the memory address and memory space of the first memory 104. The processor core 106 can run an operating system such as Windows, Android, Windows CE, or Linux. In some examples, the system 100 includes a plurality of processor cores 100, all coupled to the memory controller 102 and sharing the same memory address and memory space.

The secure core 108 can include or be coupled to a second memory 110, with its own memory address and memory space. This allows the secure core 108 to operate independently with its own memory space, as opposed to sharing the memory space of the first memory 104 with the processor core 106. The secure core 108 can monitor the activities of the processor core 106 by inspecting the first memory 104. The security core 108 can detect security events in the first memory 104, and remedy the security events in response to the detection. The secure core 108 can be protected such that the processor core 106 is unable to control, write to, disable, or reset the secure core 108. Furthermore, the secure core 108 is immune to any security event that may affect the processor core 106. The secure core 108 can operate independently from the processor core 104 such that processes running on the processor core 104 do not take a performance hit due to the secure core 108.

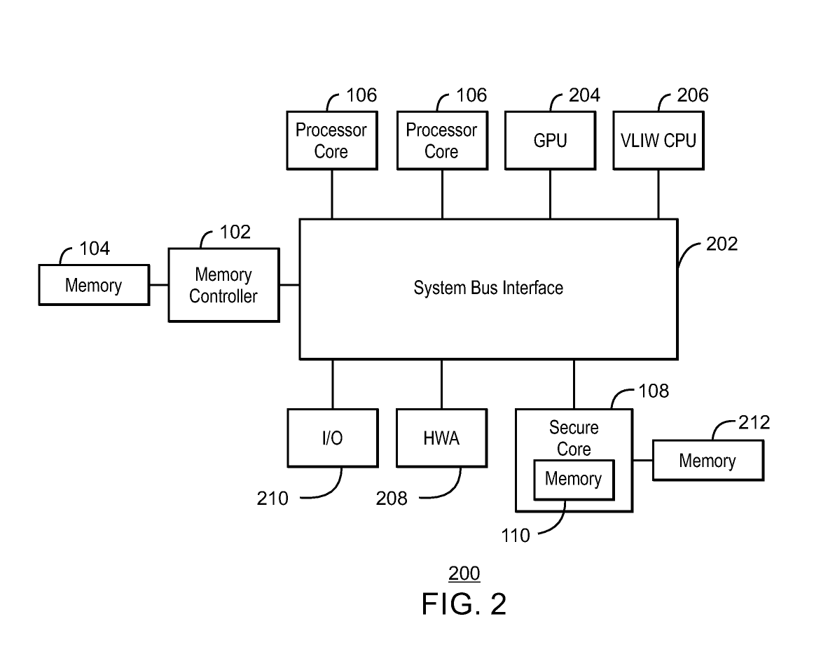

FIG. 2 is a block diagram of an example of a system for detecting a security event in a multi-core computing device. The system 200 can be an embedded system in an electronic device such as a printer or a scanner. The system 200 can include a memory controller 102 coupled to a first memory 104. The system 200 can also include a plurality of processor cores 106 and a secure core 108 coupled to the memory controller 102. The processor cores 106 can operate using the memory address and memory space of the first memory 104. The secure core 108 can include a second memory 110 so that the secure core 108 has its own memory address and memory space.

The memory controller 102 can further include a system bus interface 202 which allows cores and other computer components to interface with the memory controller 102 and use the memory address and memory space of the first memory 104. In some examples, the system 200 can include a graphics processing unit (GPU) 204, a very long instruction word (VLIW) central processing unit (CPU) 206, a hardware assist (HWA) processor 208, and an input/output (I/O) component 210 coupled to the memory controller 102 via the system bus interface 202.

The processor cores 106 can be configured to run various operating systems. In some examples, a first processor core 106 operates Windows CE while a second processor core 106 operates Linux, with both operating systems functioning within the memory space of the first memory. In some examples, the processor cores 106 can be ARM processor cores. In some examples, the first memory 104 is double data rate type three (DDR3) memory.

The secure core 108 can run a security kernel that monitors activities in the first memory 104. In some examples, the secure core 108 can use Microprocessor without Interlocked Pipeline Stages (MIPS) architecture. The security kernel can operate within the memory space of the second memory 110, isolated from the first memory 104. The secure core 108 can also have the ability to read or write to the protected second memory 110 or to the first memory 104 used by the system 200. The secure core 108 can be protected such that any other component coupled to the system bus interface 202 is unable to read or write to the secure core 108 or the second memory 110. In some examples, the second memory 110 can be a 32K cache. In some examples, a third memory 212 with its own memory space is coupled to the secure core 108 to expand or improve the capabilities of the security kernel. In some examples, the third memory 212 contains static random access memory (RAM).

The VLIW CPU 206 can be used to perform digital signal processing. In some examples, the VLIW CPU 206 can use ST231 architecture.

The HWA processor 208 can be used to perform image processing. The HWA processor 208 can include a number of engines to perform various functions, including (but not limited to) a direct memory access (DMA) engine, an image compressor, an image decompressor, a color space convertor, a color video pipeline, and a mono video pipeline.

The I/O component 210 controls and manages operations related to the flow of data to and from the system 200. The I/O component 210 can include modules to handle interrupts, serial timers, and inter-processor communication. The I/O component 210 may also include a Universal Serial Bus (USB) interface, a controller area network (CAN) bus, a Secure Digital Input Output (SDIO) interface, an Internet Protocol Security (IPsec) engine, a General Purpose Input/Output (GPIO), an Inter-Integrated Circuit (I²C) bus, and a Serial Peripheral Interface (SPI) bus.

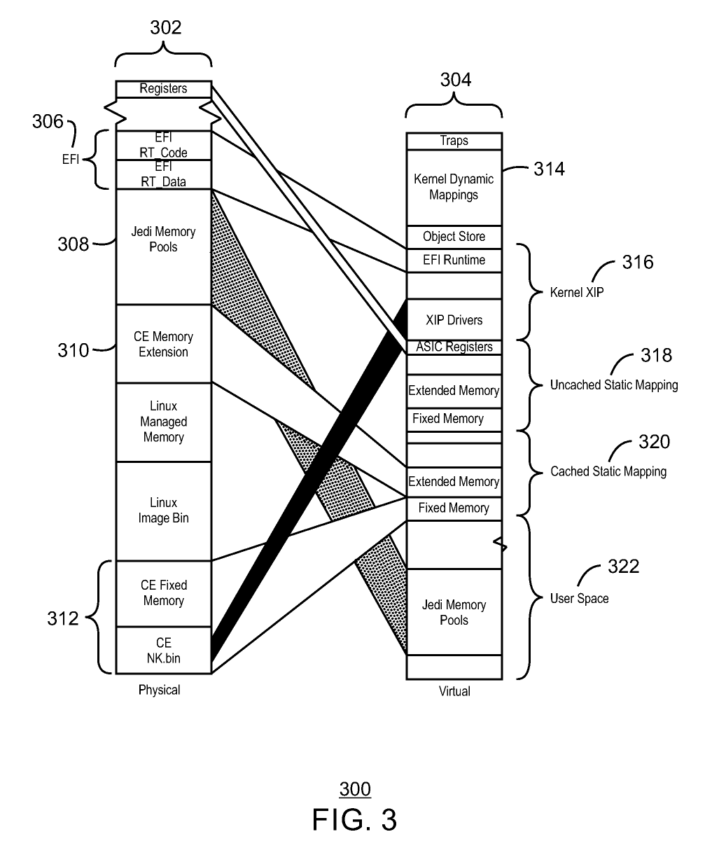

FIG. 3 is a block diagram of a mapping between physical memory and virtual memory. The physical memory 302 can represent the first memory 104 of FIGS. 1 and 2 that is coupled to the processor core 106 via the memory controller 102. The virtual memory 304 represents the memory space that is occupied by the processor core 106. The physical memory 302 contains various components, some of which can be mapped to components of virtual memory 304. The security kernel running in the secure core 108 may be configured to inspect the activities in the physical memory 302 without needing knowledge of the mappings to virtual memory 304. In some examples, the security kernel is able to perform a memory walk and inspect the virtual memory 304. A memory walk entails having the secure core 108 examine areas of system memory and inspecting it for intrusions or compromises. This may mean it scans select regions of memory that contain program instructions. The memory walk would perform a cyclical redundancy check (CRC) or any other method to verify that the integrity of the memory has not changed from a known value. The CRC is verified against the known good CRC protected in the secure core's memory space.

The physical memory 302 may contain components for Extensible Firmware Interface (EFI) 306, Jedi memory pools 308, CE memory extension 310, and CE fixed memory 312. EFI 306 is the primary boot code used to launch a device. EFI 306 is also responsible for loading whatever operating system is used. The Jedi memory pools 308 are memory reserved for hardware and imaging for the device. The Jedi memory pools 308 contain large dedicated areas for rendering and hardware assist activities. The CE memory extension 310 is expanded space for Windows CE memory. The CE fixed memory 312 is application space memory above the Windows CE operating system kernel.

The virtual memory 304 may contain components for kernel dynamic mappings 314, kernel execute-in-place (XIP) 316, uncached static mapping 318, cached static mapping 320, and user space 322. These mappings can pertain to a processor core 106. Kernel dynamic mappings 314 are operating system specific dynamic heap space. XIP 316 is memory for software loaded into the kernel considered executable. Uncached static mapping 318 and cached static mapping 320 are areas of the operating system kernel that may or may not make use of the main processor cache. These areas would be prime areas for the secure core 108 to monitor as the operating system kernel resides there and is ripe for compromise. User space 322 sits below the kernel and allows application to run in.

It is to be noted that possible components of physical memory 302 and virtual memory 304 are not limited only to those indicated in FIG. 3. Other arrangements may be possible as well.

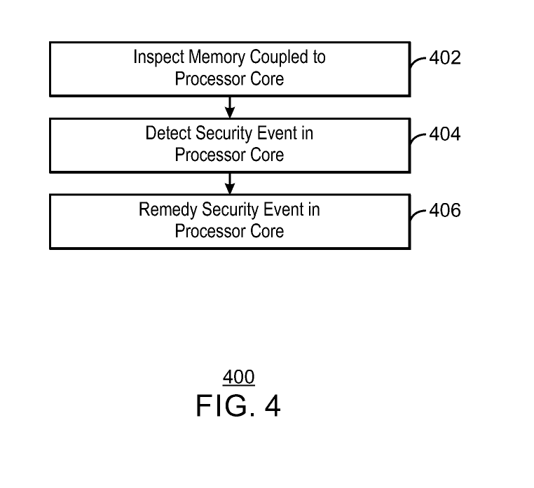

FIG. 4 is a process flow diagram of a method for detecting a security event. The method 400 can be performed by a security kernel operating in a secure core with a dedicated memory in a computing system.

At block 402, the security kernel inspects a memory coupled to the processor core. The memory may be used by the processor core along with other hardware or firmware components in the computing system.

The security kernel can validate that software being used by the processor core is authentic and has not been compromised, as well as detect changes to statically mapped areas. The security kernel can perform a validation during the initial booting of the computing system. Additionally, the security kernel can perform an inspection of the memory's layout at regular intervals, and compare the current memory layout to a known memory layout loaded from the initial booting of the computing system. Any change that has occurred may be flagged as a security event.

The security kernel can also read the page tables of the operating system being run on the processor core. By reading the page tables, the security kernel can inspect user space application, running software, and installable third-party applications. Page table reading is a more advanced form of memory walk, wherein the security kernel is able to interpret page tables of different operating systems. The security kernel may search for pages that correspond to instructions.

The security kernel can also operate a watchdog timer to inspect and monitor the health of the computing system. If the processor core or any other component in the computing system fails to respond within a specified amount of time, the security kernel can determine that a security event can flag the non-response as a security event.

Furthermore, the security kernel can communicate with targeted firmware components and network based entities to report information regarding any events or failures detected. The security kernel can check non-volatile random access memory (NVRAM) values to see if a compromise has occurred since the last reboot. The security kernel can monitor input and output traffic by inspecting data packets that enter the computing system. The security kernel can also scan for viruses and other intrusions.

At block 404, the security kernel detects a security event in the processor core. The security event can be a change in a statically mapped area of the memory that should not change or be self-modifying. The security event can be a malicious intrusion, such as a virus or a Trojan. The security event can be an unauthorized change made to any of the processes running in the memory. The security event can be a failure of the processor core or another component in the computing system to respond. The security event can also be any sort of defect that can compromise the performance of the processor core, such as a bug or glitch.

At block 406, the security kernel remedies the detected security event in the processor core. The security kernel can drive policy enforcements in response to the detected security event. The security kernel can communicate with a targeted hardware or firmware component and command the component to stop processing or to activate network filtering policies. The security kernel can also quarantine the security event by isolating the affected component from using the shared memory.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. An integrated circuit, comprising:
a memory controller;
a first memory coupled to the memory controller a processor core coupled to the memory controller; and
a secure core comprising a second memory with a discrete memory space, the secure core to inspect the first memory and detect a security event.

2. The integrated circuit of claim 1, comprising a plurality of processor cores coupled to the memory controller, wherein each of the plurality of processor cores share the same memory space.

3. The integrated circuit of claim 1, the secure core to remedy the security event.

4. The integrated circuit of claim 1, the secure core coupled to a third memory with its own discrete memory space.

5. The integrated circuit of claim 1, wherein the secure cores uses microprocessor without interlocked pipeline stages (MIPS) architecture.

6. A method, comprising:
operating a security kernel in a secured memory space;
inspecting a memory coupled to a processor core;
detecting a security event in the memory; and
remedying the detected security event.

7. The method of claim 6, comprising detecting changes to statically mapped areas of the memory.

8. The method of claim 6, comprising reading operating system page tables.

9. The method of claim 6, comprising monitoring input and output traffic.

10. The method of claim 6, comprising monitoring the responsiveness of the processor core within a specified amount of time.

11. An electronic device, comprising an integrated circuit, the integrated circuit comprising:
a memory controller;
a first memory coupled to the memory controller
a processor core coupled to the memory controller; and
a secure core comprising a second memory with a discrete memory space, the secure core to inspect the first memory and detect a security event.

12. The electronic device of claim 11, the integrated circuit comprising a plurality of processor cores coupled to the memory controller, wherein each of the plurality of processor cores share the same memory space.

13. The electronic device of claim 11, the secure core to remedy the security event.

14. The electronic device of claim 11, the secure core coupled to a third memory with its own discrete memory space.

15. The electronic device of claim 11, wherein the secure core uses microprocessor without interlocked pipeline stages (MIPS) architecture.
